(19) United States
(12) Patent Application Publication
(10) Pub. No.: US 2025/0214833 A1
(43) Pub. Date: Jul. 3, 2025

(54) METHOD FOR PRODUCING POROUS MAGNESIUM, POROUS MAGNESIUM PRODUCED THEREBY, AND HYDROGEN STORAGE MATERIAL COMPRISING HYDROGEN SUPPORTED BY POROUS MAGNESIUM

(71) Applicants: KOREA ADVANCED INSTITUTE OF SCIENCE AND TECHNOLOGY, Daejeon (KR); SAUDI ARABIAN OIL COMPANY, Dhahran (SA)

(72) Inventors: Eun Seon CHO, Daejeon (KR); Hye Sun KIM, Daejeon (KR); Jamal AQIL, Dhahran (SA); Hyeonji KIM, Daejeon (KR)

(21) Appl. No.: 18/852,442

(22) PCT Filed: Jun. 13, 2022
(86) PCT No.: PCT/KR2022/008307

§ 371 Date: Sep. 28, 2024

(30) Foreign Application Priority Data
Mar. 31, 2022 (KR) 10-2022-0040637

(51) Int. Cl. C01B 3/00

(52) U.S. Cl. CPC C01B 3/0042; C01P 2002/52; C01P 2006/12

(57) ABSTRACT

Provided are a method for producing porous magnesium having a simple solution process of adding a magnesium precursor to a reductant solution and reacting, porous magnesium produced by the method, and hydrogen storage material containing hydrogen supported in the porous magnesium.

### CROSS-REFERENCE TO RELATED APPLICATIONS

This is a U.S. national phase under 35 U.S.C. § 371 of International Patent Application No. PCT/KR2022/008307 filed Jun. 13, 2022, which in turn claims priority under 35 U.S.C. § 119 of Republic of Korea Patent Application No. 10-2022-0040637 filed Mar. 31, 2022. The disclosures of all such applications are hereby incorporated herein by reference in their respective entireties, for all purposes.

### Technical Field

The present invention relates to a method for producing porous magnesium, porous magnesium produced thereby, and hydrogen storage material comprising porous magnesium with incorporated hydrogen.

### Related Art

Fossil fuels, which are currently the most used energy source, produce greenhouse gases such as carbon dioxide and air pollutants such as fine dust, so it is essential to develop renewable energy to reduce dependence on fossil fuels in the future.

As a renewable energy source, hydrogen is a clean energy resource that produces no air pollutants when burned, and can be used in nearly every field of the energy system, including household and industrial fuel cells.

However, it is difficult to safely store hydrogen in the form of compressed gas using conventional high-pressure hydrogen storage tanks, as there is always a risk of explosion, so solid-state, material-based storage methods that can replace conventional high-pressure hydrogen storage tanks have been studied in recent years.

As a hydrogen storage material, metal hydrides are known to have high hydrogen storage capacity and, unlike conventional physical hydrogen storage methods, can be stored at relatively low hydrogen partial pressures below 100 bar.

To improve the hydrogen storage performance of the metal hydrides, attempts have been made to composite them by infiltrating the metal hydrides inside a lightweight carbon-based porous matrix, but previous carbon porous matrices suffered from low hydrogen storage capacity. In addition, a carbon nanotube, a carbon-based porous matrix material that has been widely studied in the past, requires a separate separation process to increase the purity to keep the pore size constant, which makes it uncompetitive in price.

### DETAILED DESCRIPTION OF THE INVENTION

### Technical Problem

One example is to provide a method for preparing porous magnesium that can be easily one-pot synthesized on a solution basis.

Another example is to provide porous magnesium prepared by the above method of preparing porous magnesium.

Another example is to provide hydrogen storage material that utilizes porous magnesium to improve the kinetics of hydrogen absorption and desorption and to enable hydrogen storage at relatively low pressures.

### Technical Solution

According to one example, the present invention provides a method of producing porous magnesium, comprising the step of adding a magnesium precursor to a reductant solution.

The magnesium precursor may comprise a compound prepared by dissolving a salt containing magnesium.

The salt containing magnesium may comprise MgCl₂.

The reductant solution may be a lithium-based reductant solution.

The magnesium precursor may include a mixture prepared by dissolving together a salt containing magnesium and a transition metal compound.

The transition metal compound may comprise a salt including Ni, Co, and Ti, or a combination thereof.

According to another example, the present invention provides porous magnesium prepared by the above method.

The porous magnesium may have a BET surface area of 10 m²/g or less.

The porous magnesium has a plurality of pores, wherein the average width of the pores may be 50 nm or less.

The porous magnesium may be doped with a transition metal.

The transition metal may comprise Co, Ni, Ti, or a combination thereof.

Another example provides hydrogen storage material comprising hydrogen supported in porous magnesium.

### Advantageous Effect

According to one example, the present invention provides a method for easily obtaining porous magnesium by a simple process of adding a magnesium precursor to a strong reductant solution, unlike conventional porous structure synthesis methods such as template, dealloying, and PVD methods, and the magnesium prepared by the present method has a very high hydrogen storage capacity unlike conventional porous metals, and can be very useful as a new hydrogen storage medium. Furthermore, the manufacturing method according to one example is very simple, unlike conventional manufacturing methods, and is very easy to apply to mass production processes at industrial rather than laboratory level.

### BRIEF DESCRIPTION OF DRAWING

FIG. 1 illustrates the absorption of hydrogen gas to bulk magnesium with a non-porous structure.

FIG. 2 is an illustration of hydrogen gas absorption onto porous magnesium, according to one example.

FIG. 3 illustrates the addition of a magnesium precursor, MgCl₂, to a strong reductant solution, lithium naphthalenide, wherein the MgCl₂ is reduced to porous magnesium.

FIG. 4 shows a photograph of a reduction reaction in progress in which a magnesium precursor, MgCl₂, is added to a strong reductant solution, lithium naphthalenide.

FIG. 5 is a TEM image of the porous magnesium produced after the end of the reduction reaction.

FIG. 6 and FIG. 7 are TEM and SEM images, respectively, of porous magnesium produced after the end of the reduction reaction independently.

FIG. 8 shows a comparison of hydrogen gas absorption on magnesium with a non-porous structure (left) and a porous structure (right).

FIG. 9 is a sequential illustration of the absorption of hydrogen gas onto a porous magnesium, according to one example.

FIG. 10 and FIG. 11 are graphs depicting hydrogen absorption performance on porous magnesium, according to one example, independently.

FIG. 12 and FIG. 13 are graphs depicting hydrogen desorption performance on porous magnesium, in accordance with one example, independently.

FIG. 14 is an XRD graph showing the structure immediately after synthesis of porous magnesium (before hydrogen absorption) according to one example.

FIG. 15 is an XRD graph showing the structure after hydrogen desorption from porous magnesium, according to one example.

FIG. 16 is a TEM image of the structure after hydrogen desorption from porous magnesium, according to one example.

FIG. 17 and FIG. 18 are graphs depicting hydrogen absorption performance on magnesium with Ni-doped porous structure, according to one example, each independently.

FIG. 19 and FIG. 20 are graphs depicting hydrogen desorption performance on magnesium with Ni-doped porous structure, according to one example, each independently.

FIG. 21 and FIG. 22 are graphs depicting hydrogen absorption performance on magnesium with Co-doped porous structure, according to one example, each independently.

FIG. 23 and FIG. 24 are graphs depicting hydrogen desorption performance on magnesium in Co-doped porous structure, according to one example, each independently.

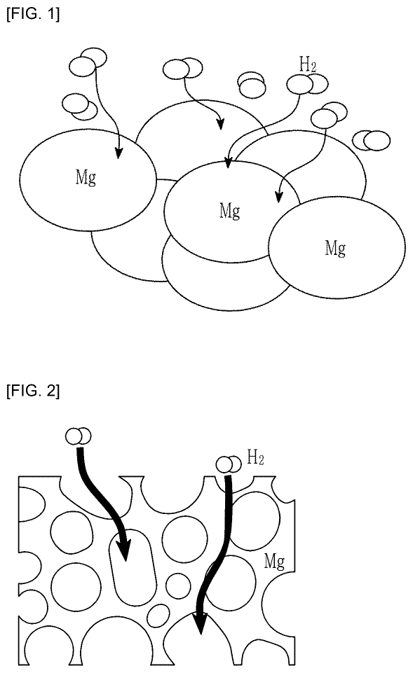

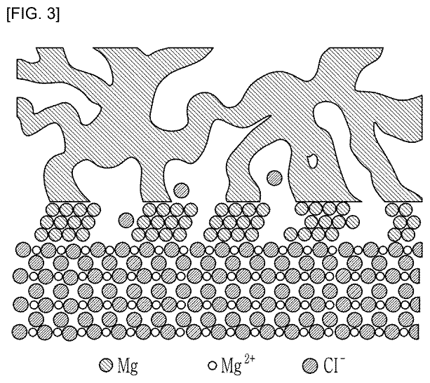

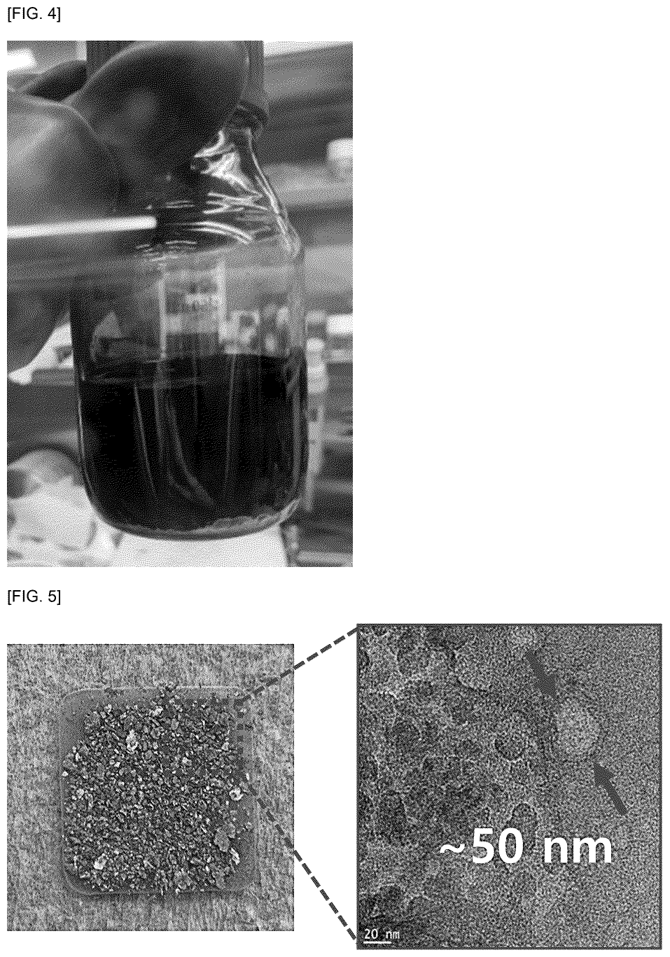

### DETAILED DESCRIPTION OF THE INVENTION

Examples of the present invention will now be described in detail to facilitate practice by one having ordinary skill in the art. However, the invention may be implemented in many different forms and is not limited to the examples described herein.

This specification does not describe all elements of the examples, and omits those that are common in the art, or that are redundant between examples.

Also, when a part “includes” a component, it means that it can include more of the other component, not that it excludes the other component, unless specifically stated to the contrary.

Expressions in the singular include the plural unless the context clearly indicates otherwise.

When a layer, film, region, plate, or the like is referred to herein as being “on top of” another, this includes not only when it is “directly above” another, but also when there is another part therebetween. Conversely, when it is said that a part is “on top of” the other component, it means that there is nothing therebetween.

The following describes a method for preparing porous magnesium according to one example.

Hydrogen has the highest energy-to-weight density of any substance. (Hydrogen has a lower heating value (LHV) of 120 KJ/g or less.) Hydrogen is one of the most abundant and environmentally friendly energy sources on the planet, and attempts to use it to generate electricity or desalinate water are currently underway around the world. (From applying hydrogen to transportation, to develop commercial vehicles such as taxis and buses, to desalinizing seawater, hydrogen is arguably the next big thing in energy.)

However, in order to utilize hydrogen as an energy source, a hydrogen storage system is required to store the hydrogen, but existing physical hydrogen storage systems require high pressure (350 to 700 bar), extreme cryogenic environments of minus 252.8° C. or less, and low energy density to volume. In addition, there are always safety concerns due to the risk of explosion, and hydrogen stored in this way is expensive, making it uneconomical.

As a result, various attempts have been made to develop new systems to store hydrogen, but no satisfactory hydrogen storage medium has yet been developed.

After fully recognizing the above background and the current problems and limitations, the inventors of the present invention conducted research and studies for many years, searching for data from all over the world, and finally realized that by modifying magnesium into a porous structure, specifically a nanoporous structure, hydrogen storage can be facilitated even at low pressure, and a safe and efficient hydrogen storage system can be built; and finally competed the present invention.

In theory, magnesium has a high hydrogen storage capacity of 7.6% by weight and a high gravimetric density for a light metal. It is also an abundant element on Earth, which makes it cost-effective, has a moderate equilibrium pressure for hydrogen, allowing hydrogen storage at relatively low hydrogen pressures below 100 bar, and has a high reversible energy density of 9 MJ/kg.

However, the kinetics of hydrogen are disadvantageous because the absorption/desorption rate is too slow, the hydrogen release process requires high temperatures at least 330° C., and, most importantly, complete hydrogenation to the inside of the magnesium is difficult. Furthermore, magnesium is a highly reactive element, meaning it is oxidized easily in air. Despite the advantages of magnesium, these critical drawbacks have prevented it from being used as a hydrogen storage medium to date.

However, according to one example, by modifying the magnesium (bulk Mg) into a nanoporous structure, more specifically a nanoporous structure doped with a transition metal, all of the aforementioned disadvantages are overcome and a very superior hydrogen storage medium is provided that has not been available before.

More precisely, one example provides a very easy way to synthesize nanoporous magnesium in a one-pot process in solution, by using a magnesium precursor from scratch, rather than by modifying the magnesium (bulk Mg).

In other words, one example provides a method for preparing porous magnesium by adding a magnesium precursor to a reductant solution.

Magnesium prepared by the method according to one example has a nanoporous structure, which can significantly improve hydrogen absorption/desorption performance.

Specifically, structural collapse of the magnesium can occur due to volume expansion that occurs with each repeated absorption/desorption of hydrogen, and the magnesium prepared by the method according to one example has a nanoporous structure, which can i) greatly mitigate the risk of structural collapse as described above, ii) reduce the Mg ligament size, which is advantageous in terms of kinetics by reducing the distance hydrogen has to travel to react with the magnesium, iii) increase the surface area available to react with hydrogen, resulting in a decrease in the equilibrium pressure (P_{eq}), iv) reduce the amount of unreacted magnesium inside, which can significantly increase the hydrogenation progress, and v) potentially eliminate the need for high temperatures during hydrogen release.

Ultimately, using the methods according to one example, nanoporous magnesium can be readily obtained, which facilitates hydrogen storage even at low pressures, making it an important medium for building safe and efficient hydrogen storage systems.

In other words, one example provides a novel solid hydrogen storage material by making porous magnesium, which has been little studied to date, have a nanoporous structure, and provides a novel method for the preparation of a novel solid hydrogen storage material by enabling easy mass production by solution-based one-pot synthesis. (Existing methods for synthesizing porous structures include template methods and dealloying methods, all of which are not solution-based synthesis methods and therefore cannot be used for one-pot synthesis, and the quality of the resulting porous structures is not suitable for safe and efficient storage of solid hydrogen at low pressure.)

For example, the magnesium precursor may comprise a compound prepared by dissolving a salt containing magnesium.

For example, the salt containing magnesium may comprise MgCl₂.

When MgCl₂, a salt containing magnesium, is added to the reductant solution, the reaction shown in Reaction Formula 1 below occurs.

MgCl₂+2e⁻→Mg+2Cl⁻ [Reaction Formula 1]

This means that when MgCl₂ is added to a reductant solution, the porous structure can be easily synthesized by chemical reduction, utilizing the change in volume per mole between MgCl₂ and pure magnesium.

For example, the reductant solution may be a lithium-based reductant solution.

If a lithium-based reductant solution is used as the reductant solution, MgCl₂ can be easily reduced to Mg due to the reduction potential difference.

For example, lithium naphthalenide can be used as the lithium-based reductant solution, wherein the lithium naphthalenide is a strong reductant, and the lithium ions generated through the reduction reaction can be well solubilized in the THF solution used during the reaction. However, the type of lithium-based reductant solution is not necessarily limited to the above, and various combinations of metals and radical anions can be used as the reductant solution.

It is the first attempt to prepare a porous magnesium by adding the above magnesium precursor to a reductant solution, which is a very simple synthesis method of porous magnesium, and the porous structure prepared by the above synthesis method has pores having a width of about 50 nm or less, which is very advantageous for safe and effective storage and release of solid hydrogen at low pressure.

For example, the magnesium precursor may comprise a mixture prepared by melting together a salt comprising magnesium and a transition metal compound.

In other words, according to a method of preparation according to one example, a magnesium precursor comprising a mixture prepared by melting together a salt comprising the magnesium and a transition metal compound can be added to the reductant solution, in which case a bimetallic magnesium having a porous structure can be synthesized by the transition metal doping, and the hydrogen absorption/desorption rate can be further improved compared to before the transition metal doping. (kinetic improvement) In other words, the above transition metal doping can act as a catalyst for the hydrogen absorption/desorption performance of nanoporous magnesium.

For example, the transition metal may include, but is not necessarily limited to, Ni, Co, Ti, or combinations thereof.

While one example claims a method for producing porous magnesium using a magnesium precursor, it is possible that the same method can be applied to produce porous metals using highly reactive metals other than magnesium.

According to another example, the present invention provides porous magnesium prepared by the above method.

For example, due to the advantage of its porous structure, the porous magnesium according to one example can react with significant amounts of hydrogen and exhibits enhanced kinetics in the process of hydrogen absorption and release, making the porous magnesium prepared by the method according to one example very effective as a storage medium for storing hydrogen and then utilizing it again.

For example, the porous magnesium may have a plurality of pores, wherein the pores have an average width of 50 nm or less. (see FIG. 5)

For example, the porous magnesium may be doped with a transition metal.

For example, the transition metal may include, but is not necessarily limited to, Co, Ni, Ti, or combinations thereof.

Another example provides hydrogen storage material comprising hydrogen supported in porous magnesium.

### Mode for Practicing the Invention

The above-mentioned examples of the present invention will be described in more detail in the following examples. However, the following examples are for purposes of illustration only and are not intended to limit the scope of the invention.

### Manufacturing Nanoporous Magnesium

As shown in FIG. 8, a magnesium precursor comprising MgCl₂ was added to a lithium naphthalenide reductant solution, and then the lithium salt was removed (dissolved) to synthesize nanoporous magnesium.

### Evaluation 1

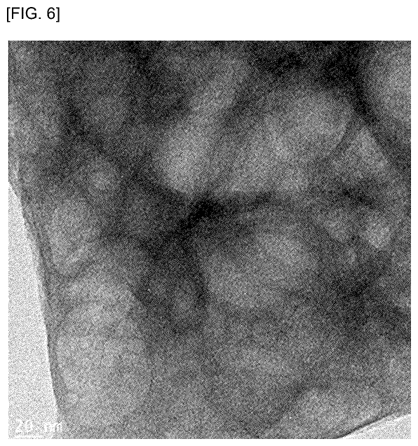

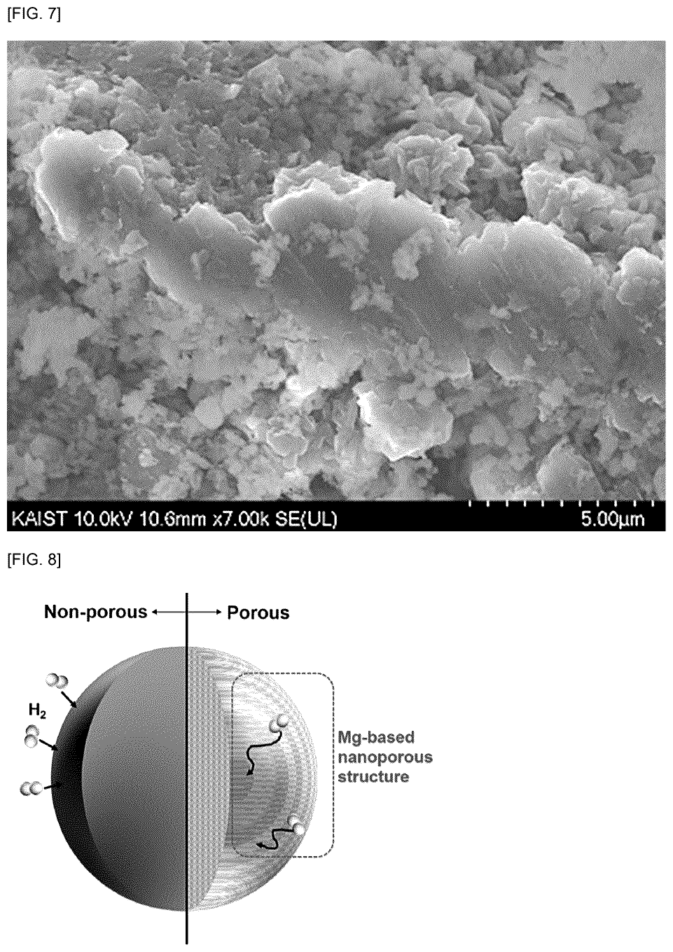

SEM and TEM photographs of the nanoporous magnesium synthesized above were taken, and the results are shown in FIG. 5 to FIG. 7. As shown in FIG. 5 to FIG. 7, it can be seen that the synthesized nanoporous magnesium has pores having a width of 50 nm or less.

### Hydrogen Absorption on Nanoporous Magnesium

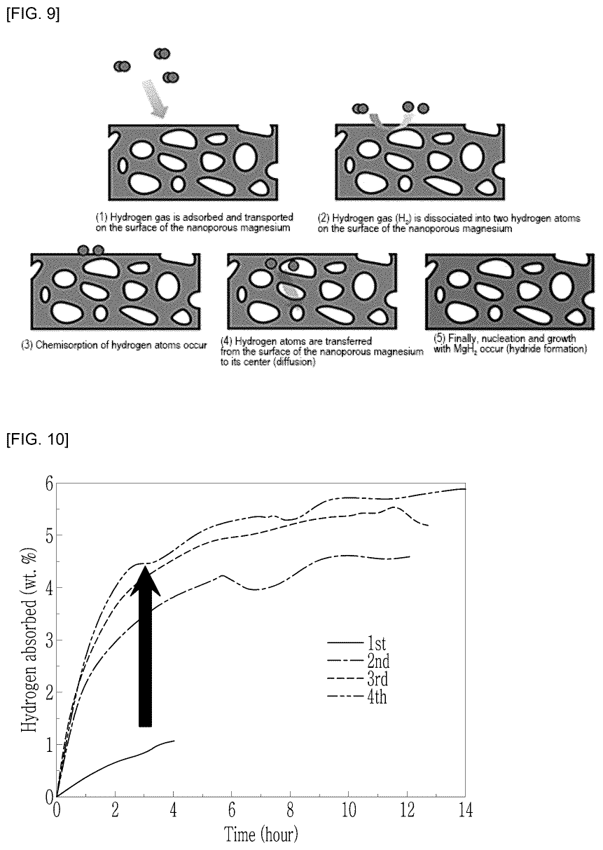

As shown in FIG. 9, hydrogen gas was absorbed on the nanoporous magnesium synthesized above. Specifically, (1) hydrogen gas was adsorbed and transported on the surface of the nanoporous magnesium, (2) hydrogen gas (H₂) was dissociated into two hydrogen atoms on the surface of the nanoporous magnesium, and (3) chemisorption of hydrogen atoms occurred. Then, (4) hydrogen atoms were transferred from the surface of the nanoporous magnesium to its center (diffusion), and (5) finally, nucleation and growth with MgH₂ (hydride formation) occured, making the nanoporous magnesium a hydrogen storage material.

### Nanoporous Mg Hydrogen Absorption/Desorption Performance Analysis

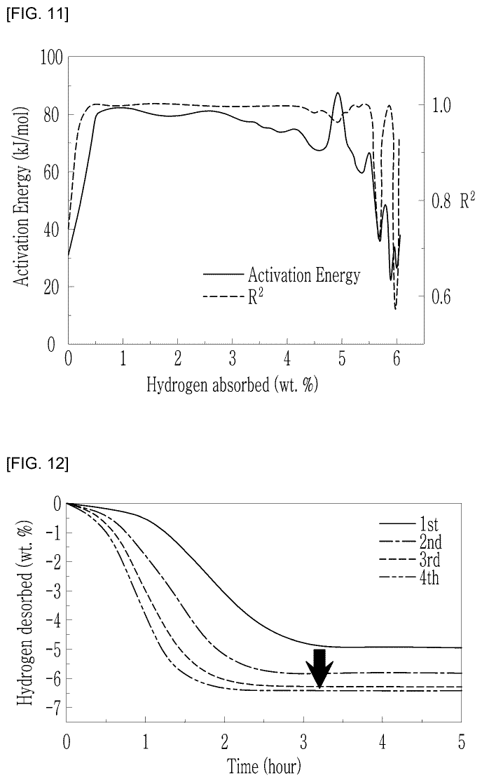

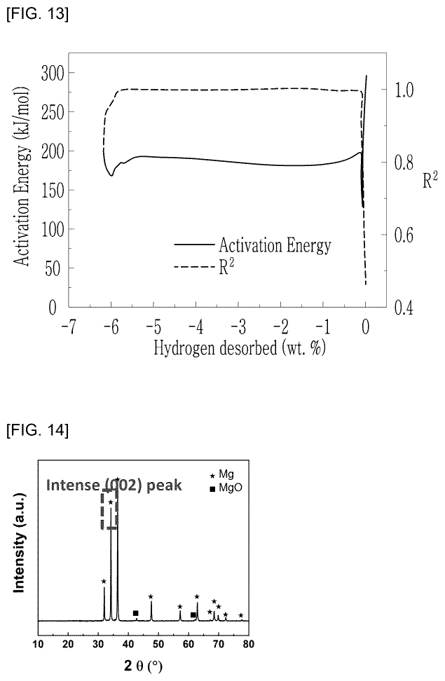

FIG. 10 to FIG. 13, it can be seen that as the absorption/desorption cycle of hydrogen progresses, the rate becomes faster and the storage capacity increases. From this, it can be seen that nanoporous magnesium according to one example has a much lower energy barrier than non-porous magnesium.

### Structural Analysis Before and After Hydrogen Absorption/Desorption Cycling (XRD, TEM Analysis)

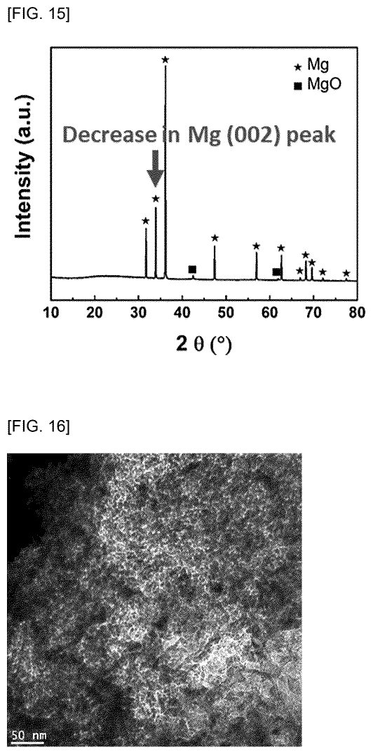

FIG. 14 to FIG. 16, it can be seen that the (002) peak before hydrogen storage is very high, while the (002) peak after cycling is significantly lower, which can be inferred that the Mg crystalline state is gradually restored to equilibrium during hydrogen cycling and the hydrogen storage performance is improved.

### Hydrogen Storage Performance and Activation Energy for Mg/Ni Bimetal and Mg/Co Bimetal

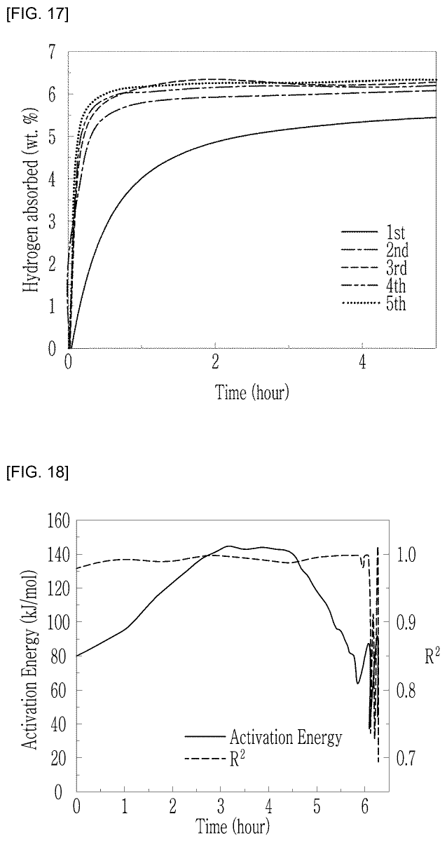

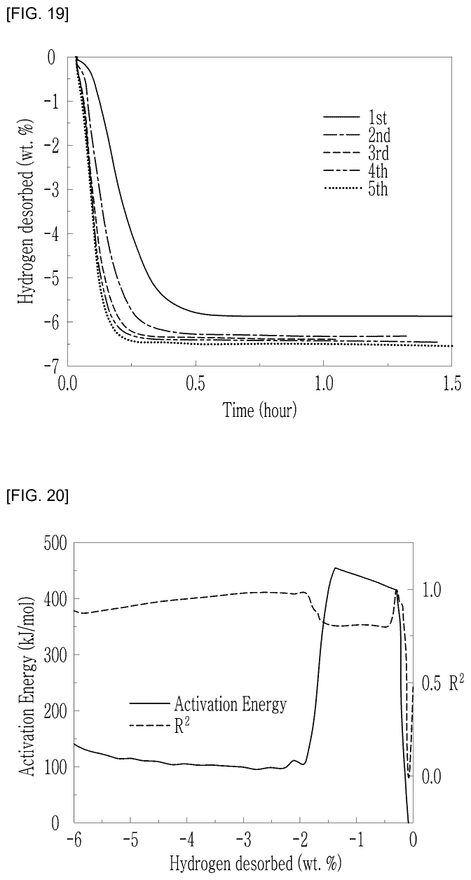

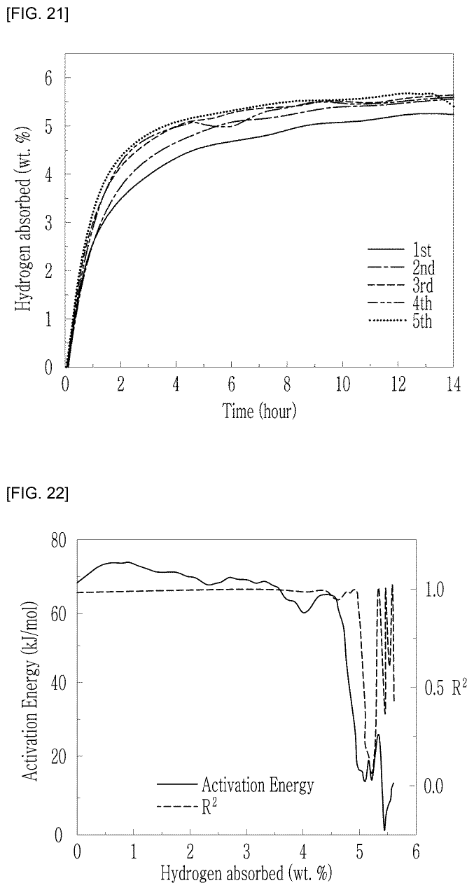

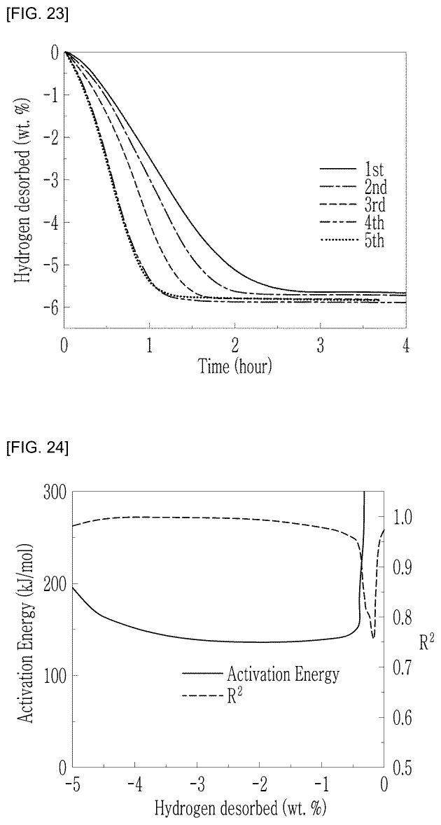

FIG. 17 to FIG. 24, it can be seen that the introduction of small amounts of transition metals Ni and Co significantly accelerated the hydrogen absorption/release kinetics and shortened the required activation process. (This is consistent with the XRD results of Mg/Ni and Mg/Co, which show a low (002) peak even before cycling.) Furthermore, activation energy calculations show that the energy barrier for hydrogen absorption/desorption is also lower than that of porous magnesium which is not doped with a transition metal (In particular, the energy barrier for hydrogen desorption is much lower.). It can be seen that the introduction of a transition metal into magnesium generally results in a lower hydrogen storage capacity, whereas the introduction (doping) of a transition metal into the nanoporous magnesium above can further improve the kinetics while maintaining a higher hydrogen storage capacity (rather than lowering the hydrogen storage capacity).

While preferred examples of the present invention have been described in detail above, the scope of the invention is not limited thereto, and various modifications and improvements by those skilled in the art utilizing the basic concepts of the invention as defined by the following claims are also within the scope of the invention.

1. A method for producing porous magnesium, comprising adding a magnesium precursor to a reductant solution.

2. The method for producing porous magnesium of claim 1, wherein the magnesium precursor comprises a compound prepared by dissolving a salt containing magnesium.

3. The method for producing porous magnesium of claim 2, wherein the salt containing magnesium comprises MgCl₂.

4. The method for producing porous magnesium of claim 1, wherein the reductant solution is a lithium-based reductant solution.

5. The method for producing porous magnesium of claim 1, wherein the magnesium precursor comprises a mixture prepared by dissolving together a salt comprising magnesium and a transition metal compound.

6. The method for producing porous magnesium of claim 5, wherein the transition metal compound comprises a salt comprising Ni, Co, Ti, or a combination thereof.

7. Porous magnesium prepared by the method of claim 1.

8. The porous magnesium of claim 7, wherein the porous magnesium has a BET surface area of 10 m²/g or less.

9. The porous magnesium of claim 7, wherein the porous magnesium has a plurality of pores, and the average width of the pores is 50 nm or less.

10. The porous magnesium of claim 7, wherein the porous magnesium is doped with a transition metal.

11. The porous magnesium of claim 10, wherein the transition metal comprises Co, Ni, Ti, or a combination thereof.

12. A hydrogen storage material comprising hydrogen supported in porous magnesium of any one of claims 7 to 11.
